(19) United States
(12) Patent Application Publication
(10) Pub. No.: US 2025/0232688 A1
(43) Pub. Date: Jul. 17, 2025

(54) REMOTE TEACHING OF A PERCUSSION INSTRUMENT

(71) Applicant: INTERNATIONAL BUSINESS MACHINES CORPORATION, ARMONK, NY (US)

(72) Inventors: John McNamara, Winchester (GB); Stefan Jan Kwiatkowski, Chandlers Ford (GB)

(21) Appl. No.: 18/430,708

(22) Filed: Feb. 2, 2024

(30) Foreign Application Priority Data
Jan. 11, 2024 (GB) 2400377.4

(51) Int. Cl. G09B 15/00; G10H 1/00

(52) U.S. Cl. CPC G09B 15/00; G10H 1/0008; G10H 2210/385; G10H 2220/185; G10H 2220/201; G10H 2250/311; G10H 2250/435

(57) ABSTRACT

A method, computer program product, and computer system are provided for remote teaching of a percussion instrument. The method includes recording reference movement data from a reference drumstick over a period of time, analyzing the reference movement data to generate teaching instructions for movement of a learner drumstick to emulate the reference movement data, and transmitting the teaching instructions to provide teaching instruction indications at the learner drumstick over a period of time. The method further includes receiving learning movement data from the learner drumstick in response to the teaching instruction indications, altering the timing of the teaching instruction indications based on a difference between learning movement data and reference movement data at a given point of time in the period of time of the reference movement data to compensate for differences between the learner movement data of the learner drumsticks and the reference data of the reference provider drumsticks.

### BACKGROUND

The present invention relates to remote teaching of a percussion instrument and, more specifically, to remote teaching of a percussion instrument through drumstick feedback.

Learning how to play a percussion instrument, such as the drums, can have an extremely beneficial impact for children with learning challenges relating to autism or attention deficit hyperactivity disorder (ADHD). However, the process of learning how to play the drums can be challenging for those with such conditions, particularly being taught in a classroom with many new people, where the people are playing instruments which are making loud noises, and the challenge of interacting with tutors who are in close physical proximity.

There is required is a way for learners to be able to learn and play percussion instruments in a manner that is sensitive to learning challenges relating to conditions such as autism. A method is required that allows the learner to learn to play the instrument in a natural and intuitive way, in a space which is familiar and comfortable.

### SUMMARY

According to an aspect of the present invention there is provided a computer-implemented method for remote teaching of a percussion instrument, the method including recording reference movement data from a reference drumstick over a period of time, analyzing the reference movement data to generate teaching instructions for movement of a learner drumstick to emulate the reference movement data, and transmitting the teaching instructions to provide teaching instruction indications at the learner drumstick over a period of time.

According to another aspect of the present invention there is provided a system for remote teaching of a percussion instrument, the system including a computing device including a processor and a memory configured to provide computer program instructions to the processor to execute the function of the following components: a reference data recording component recording reference movement data from a reference drumstick over a period of time, a teaching component for analyzing the reference movement data to generate teaching instructions for movement of a learner drumstick to emulate the reference movement data, and an instruction transmitting component for transmitting the teaching instructions to provide teaching instruction indications at the learner drumstick over a period of time.

According to a further aspect of the present invention there is provided a computer program product for remote teaching of a percussion instrument, the computer program product including a computer readable storage medium having program instructions embodied therewith, the program instructions executable by a processor to cause the processor to: record reference movement data from a reference drumstick over a period of time, analyze the reference movement data to generate teaching instructions for movement of a learner drumstick to emulate the reference movement data, and transmit the teaching instructions to provide teaching instruction indications at the learner drumstick over a period of time.

The computer readable storage medium may be a non-transitory computer readable storage medium and the computer readable program code may be executable by a processing circuit.

### BRIEF DESCRIPTION OF THE DRAWINGS

Embodiments of the present invention will now be described, by way of example only, with reference to the accompanying drawings:

FIG. 1 is a schematic diagram of an example embodiment of a system in accordance with embodiments of the present invention;

FIG. 2 is a flow diagram of an example embodiment of a method in accordance with embodiments of the present invention;

FIG. 3 is a block diagram of an example embodiment of a system in accordance with embodiments of the present invention; and

FIG. 4 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are described for remote teaching of a percussion instrument.

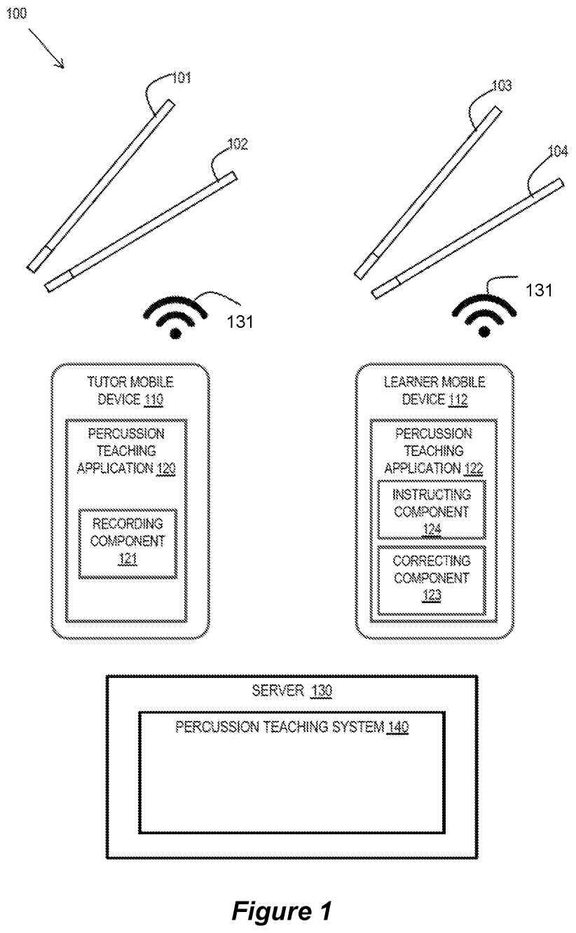

Referring to FIG. 1, a schematic diagram 100 shows an example embodiment of a described system for remote teaching of a percussion instrument using at least one drumstick. An instructor, tutor or user uses one or a pair of reference drumsticks 101, 102 to record reference movement data over a period of time. For example, the period of time may be the duration of a piece of music or a learning exercise. The reference drumstick(s) 101, 102 may have one or more movement sensors for obtaining movement data of the reference drumstick(s) 101, 102 over time. The reference drumstick(s) 101, 102 may include a communication component for transmitting data to a nearby tutor mobile device 110 via a wireless network 131.

A learner or user uses one or a pair of learner drumsticks 103, 104. The learner drumstick(s) 103, 104 may have one or more movement sensors for obtaining movement data of the drumstick. The learner drumstick(s) 103, 104 may include a communication component for transmitting data to a nearby learner mobile device 112 via the wireless network 130. The learner drumstick(s) 103, 104 may include a feedback mechanism for providing an indication to a user of the drumstick regarding timing and movement of the drumstick. The learner drumstick(s) 103, 104 may have one or more movement sensors for obtaining movement data of the learner drumstick(s) 103, 104 over time. The feedback mechanism may be a haptic indication mechanism, a visual indication mechanism, and/or a sound indication mechanism. The reference drumsticks 101, 102 may be the same form of drumsticks as the learner drumsticks 103, 104 and may include the feedback mechanism. Alternatively, the reference drumsticks 101, 102 may be different to the learner drumsticks 103, 104, for example, by including more sensors or less sensors.

A tutor mobile device 110 may include a percussion teaching application 120 associated with a percussion teaching system 140 at a server 130. A learner mobile device 112 may include a percussion teaching application 122 associated with the percussion teaching system 140 at the server 130. The percussion teaching application 120, 122 may have different versions or functionality for a tutor and a learner or may include both sets of functionalities in a single application. The tutor percussion teaching application 120 may include a recording component 121. The learner percussion teaching application 122 may include an instructing component 124 and a correcting component 123. Additionally, the learner percussion teaching application 122 may include the recording component 121, and the tutor percussion teaching application 120 may include the instructing component 124 and the correcting component 123.

Reference movement data of the one or pair of reference drumsticks 101, 102 may be transmitted from the drumstick sensors via the wireless communication 131 to the tutor mobile device 110 where it may be recorded by the recording component 121 of the percussion teaching application 120. The recording may be carried out through the tutor mobile device 110 and, optionally, transmitted to the server 130 for processing by the percussion teaching system 140. Alternatively, the reference movement data may be recorded directly at the server 130.

The percussion teaching application 122 of the learner mobile device 112 may include the instructing component 124 for instructing the learner's movement of the learner drumstick(s) 103, 104 in real time. The learner mobile device 112 may transmit teaching instructions to provide teaching instruction indications at the learner drumstick(s) 103, 104 over a period of time. The teaching instructions are generated by the percussion teaching system 140 using the reference movement data of the one or pair of reference drumsticks 101, 102 recorded via the tutor mobile device 110 and processed by the percussion teaching system 140 to provide the teaching instructions over a period of time.

The percussion teaching application 122 of the learner mobile device 112 may include the correcting component 123 for correcting the learner's movement of the learner drumstick(s) 103, 104 in real time. The learner mobile device 112 may receive learning movement data from one or both of the learner drumsticks 103, 104 and may transmit this to the percussion teaching system 140. The learning movement data may be provided by the learner playing without the teaching instructions. In real time, the percussion teaching system 140 may provide correction instructions to the learner based on a difference between learning movement data of the learner drumstick(s) 103, 104, and reference movement data of the reference drumsticks 101, 102 at a given point of time in the period of time of the reference movement data. The correction instructions may be transmitted via the percussion teaching application 122 to the learner drumstick(s) 103, 104 to provide correction instruction indications at the learner drumstick(s) 103, 104 in real time.

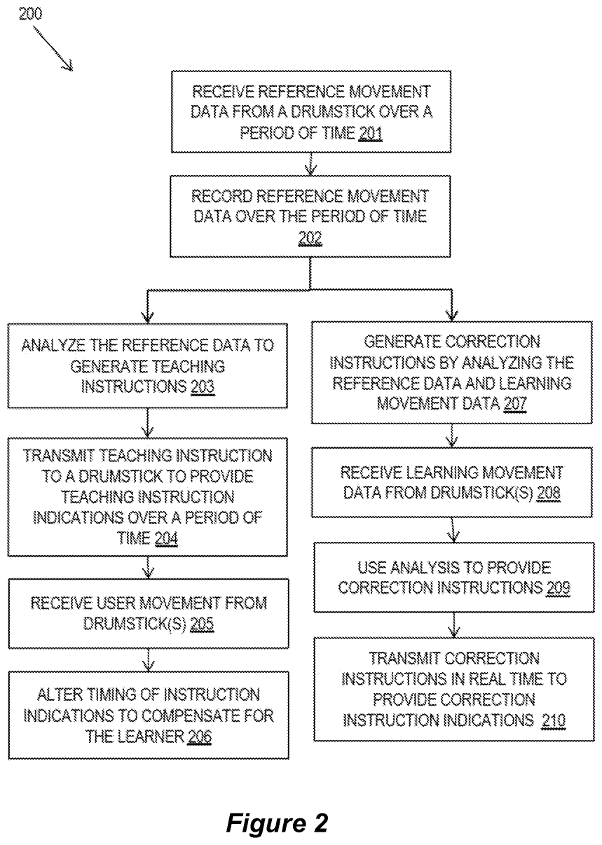

Referring to FIG. 2, a flow diagram 200 shows an example embodiment of the described computer-implemented method for remote teaching of a percussion instrument.

The method may receive, step 201, reference movement data from one or a pair of reference drumstick(s) 101, 102, over a period of time. The reference movement data may be captured by sensors in the reference drumstick(s) 101, 102 and transmitted via a tutor mobile device 110 to a server 130. The method may record, step 202, the reference movement data over the period of time. The reference movement data may include accelerometer data and impact sensor data received from the reference drumstick(s) 101, 102. The reference movement data may be synchronized between a pair of the reference drumstick(s) 101, 102 being played at the same time.

In one branch of the method, the reference data may be analyzed, step 203, to generate teaching instructions for movement of the learner drumstick or pair of drumsticks 103, 104, to emulate the reference movement data. The teaching instructions may be generated by a machine learning model receiving the recorded tutor movement data and outputting the required indications for the learner drumstick(s) 103, 104. The method may transmit, step 204, the teaching instructions to provide teaching instruction indications at the learner drumstick(s) 103, 104, over a period of time. Teaching instructions may include one or more of the group of: timing instructions, direction instructions, speed instructions, and force instructions. Teaching instruction indications may be provided by an indication mechanism in the learner drumstick(s) 103, 104, to provide one or more of the group of: haptic indications, visual indications, and sound indications.

The machine learning is described further below and may take as training inputs: the sound of drum music beats from different types of music that require the learner to learn how to physically move the learner drumstick(s) 103, 104 for playing each type of music—for example, with respect to cadence, force, and movement; and reference movement data representing the physical characteristics of the movement exerted by the tutor on the reference drumstick(s) 101, 102 when playing each particular type of music.

The trained system may receive as input a new piece of music and output the teaching instructions from learned required physical characteristics of the movement of the reference drumstick(s) 101, 102.

The method may include receiving, step 205, learning movement data from the learner drumstick(s) 103, 104, in response to the teaching instruction indications, and altering, step 206, a timing or speed of the teaching instruction indications based on a difference between learning movement data and reference movement data at a given point of time in the period of time of the reference movement data to compensate for differences of the learner using the learning drumstick(s) compared to a reference provider playing the reference drumstick(s) 101, 102.

Altering the teaching instruction indications may be determined by machine learning from analyzing learning movement data received from multiple learners' drumstick(s) 103, 104.

In this way, teaching instructions may be transmitted to the learner drumsticks(s) 103, 104, over the period of time to provide teaching instruction indications through the learner drumstick(s) 103, 104 to guide the learner to move the drumsticks to emulate the movement of movements of the reference drumstick(s) 101, 102 of the tutor.

In a second branch of the method, the method may continue from step 202 to generate, step 207, correction instructions by analyzing learning movement data received from multiple learners' drumstick(s) 103, 104, and processing differences between learning movement data and reference movement data at a given point of time in the period of time of the reference movement data.

Generating, step 207, correction instructions by analyzing learning movement data received from multiple learners' drumstick(s) 103, 104, may be carried out by machine learning of differences between reference movement data and learning movement data and required correction instructions.

The method may receive, step 208, learning movement data from a learner drumstick or pair of drumstick(s) 103, 104. The learning movement data may be unsupervised, meaning that it was generated without the instruction indications of the first branch of the method, step 203-step 206. The method may provide, step 209, correction instructions based on a difference between learning movement data and reference movement data at a given point of time in the period of time of the reference movement data and selection of the generated correction instructions in real time in response to received learning movement data.

Machine learning may be used to generate the correction instructions. The machine learning for the correction instructions may take as input the learning corrections provided for multiple learner users and the outcome of the correction instructions to learn which correction instructions provide the most improvement. The machine learning system may isolate the correction focus between cadence, force, and movement, and may provide correction instructions for one selected focus. The machine learning may provide guidance as a sequence of the order in which the focus should be corrected, i.e. first cadence, followed by force, followed by movement.

The method may transmit, step 210, the correction instructions to the learner and provide correction instruction indications at the learner drumstick(s) 103, 104, in real time. The correction instruction indications may be provided by an indication mechanism in the learner drumstick(s) 103, 104 to provide one or more of the group of: haptic indications, visual indications, and sound indications. Correction instructions may include corrections to one or more of the group of: corrections to timing, corrections to speed, and corrections to force of impact.

In this way, correction instructions may be transmitted to the learner drumsticks(s) 103, 104, over the period of time to provide correction instruction indications through the learner drumstick(s) 103, 104 to guide the learner to correct the movement of the learner drumstick(s) 103, 104 to emulate the movement of the reference movements of the tutor.

In both branches, steps 203-206 and steps 207-210, the method may include adjusting a speed of the reference movement data by the learner to enable the teaching instructions or the correction instructions to be provided at a different speed, for example, by slowing it down when first learning and then speeding up as the learner becomes proficient.

Machine learning may be used in both the generation of teaching instructions and the generation of correction instructions.

For the generation of teaching instructions, a machine learning system is used to determine accurate reference movement data, including cadence and force, to replicate a drum beat from a sound of a drum beat that it has not been specifically trained on before. This enables the application to create play instructions for new drum music that the application has not been trained on before, which expands the utility and cost effectiveness of the application.

The machine learning system may be trained on the following inputs: the sound of drum music beats from an array of different types of drum music with different requirements for drumstick movement including: drum cadence; drum beat force; and drum beat movement; and the reference movement data generated in response to the tutor playing each type of music. Such reference movement data may provide information on amongst other things the physical movement characteristics of: drum cadence (speed of drum beat) and drum force (power of drum beat).

The machine learning system is trained on the above data and is then able to receive new drum music beats that it has not specifically been trained on, and generate as output an accurate level of instruction which the learner can follow to play/learn the new drum based music. The output instruction that is generated includes: drum cadence; drum beat force; and drum beat movement.

For the generation of learning corrections, machine learning can also be used to provide optimal learning corrections in order to help the learner improve their drum beat, cadence, and force on the learning drumstick(s) 103, 104.

This can be done by analyzing the variety of feedback that is provided to the learner by the application in order to support their improved accuracy of playing the drum sequence on the learning drumstick(s) 103, 104. Machine learning may analyze which method sequence of corrective action has resulted in the most learners playing the drum piece proficiently in the least number of attempts.

As an illustration, the application may provide instructions based on a number of corrective feedback including: cadence; force; and drumstick movement. Based on the above corrective feedback options, the application will select from the list a particular option to begin corrective action (e.g. cadence) for a particular piece of music. As the application helps other students with this piece of music, it may select other options to begin with (e.g. force).

The application may utilize machine learning to analyze which sequence from the selection (e.g. cadence, or force, or drumstick movement, in which order) resulted in the most effective learning experience (based on the number of attempts by the learner and progress toward matching the tutor's instructions) for the most students.

Once the most effective sequence of learning feedback method has been determined for a particular piece of music, this can then be used as the best practice feedback method for all learners for that drum sequence.

The reference drumstick(s) 101, 102 and the learner drumstick(s) 103, 104 may be intelligent drumsticks that include an indication mechanism in the form of a vibration motor (or other form of indication such as a light), an impact sensor and an accelerometer. A communication component is provided in the reference drumstick(s) 101, 102 and the learner drumstick(s) 103, 104 in the form of a short-range wireless technology receiver and transmitter for communication with a mobile application that can be run from a mobile device such as a the tutor mobile device 110 and the learner mobile device 112, which is used to store and distribute the data received from the reference drumstick(s) 101, 102 and the learner drumstick(s) 103, 104.

In one embodiment, the reference drumstick(s) 101, 102 and the learner drumstick(s) 103, 104 and the tutor mobile device 110 and the learner mobile device 112 may be set to ‘record’ the motion, and rhythm of a tutor playing a set of drums to a piece of music. The movement and impact are transmitted via the wireless communication to the mobile application which generates and provides the sequence, ready to be consumed as a ‘guide’ by the learner.

When the learner attempts to play the same piece of music, the stored sequence is transmitted from the learner mobile device 112 application to the learner drumstick(s) 103, 104, which may then use a drumstick vibration function to guide the user to raise the learner drumstick(s) 103, 104 to a correct height, and then again to trigger downward movement. Further guidance and corrective feedback may be given as to the amount of force a drum would be hit by the learner drumstick(s) 103, 104, by utilizing the data collected from the reference drumstick(s) 101, 102 accelerometer by the tutor, where the learner drumstick(s) 103, 104 may vibrate to alert the learner that their strike is too hard or soft.

As this system guides by touch, it allows users who have sight challenges to learn and play a musical instrument more easily. Alternatively or additionally, the system may use light indications to guide the learner. This system may allow the learner to be both guided and corrected, based directly on the play style of the tutor.

This system allows the user to learn effectively even when remote from the tutor. By having access to the stored sequence created by the tutor and distributed by the system the learner is still able to interact in an intuitive way with the tutor's expertise. The system also allows the benefit of being able to slow the sequence down, in order to better grasp the technique, before speeding up to the correct cadence.

The system allows learners with conditions that make learning in groups challenging, access to musical tuition in a cost-effective way that matches their needs for learning.

A first example use case is described. A tutor initiates the percussion teaching application 120 on the tutor mobile device 110 and ensures connection to the reference drumstick(s) 101, 102 and the learner drumstick(s) 103, 104, and initiates the application record function. The tutor then begins to play the music using the reference drumstick(s) 101, 102. Data collected from the impact sensor (when striking a drum), the accelerometer (when moving the drumstick up away from the drum, and down toward the drum) is transmitted to the mobile application as reference movement data. The tutor concludes their piece and stops the mobile application record function. The tutor then makes this recording available for use by his learners through the percussion teaching application 122. The system processes the recording (reference movement data) to generate the instruction indications and/or correction indications for consumption by the learner when playing the same piece of music on the learner drumstick(s) 103, 104 or carrying out the exercise.

A second example use case is described. The learner receives the lesson remotely at the mobile application of the learner mobile device 112. The learner initiates the percussion teaching application 122 and ensures connection to the learner drumstick(s) 103, 104 and starts the application's ‘play’ function.

The learner places the learner drumstick(s) 103, 104 in the ‘ready’ position, and the learner drumstick(s) 103, 104 vibrate to indicate the learner should raise the learner drumstick(s) 103, 104 away from the drum, and then vibrates again to indicate the learner should swing down to strike the drum. The percussion teaching application 122 will analyze the movement of the learner through the accelerometer and the impact sensor and may alter the timing of the vibrations on the up/down movement to compensate for learners' physical use of the learner drumstick(s) 103, 104 differences to the tutor (such as length of arm). After a number of attempts the learner may feel that could improve their effectiveness, by slowing down the cadence of the movements in order to master the technique correctly, and so selects the option to play at a reduced speed. Once the learner indicates that they have mastered the movements and rhythm, the application can slowly increase the speed until the learner is able to play at the correct pace.

The method and system include the ability for artificial intelligence in the system to consume the data created by the tutor (when creating the initial teaching experience) and then utilize this data to be able to take as input non-trained percussion music, and to create as output the learning experience (such as the motion of the drum sticks, when the drum should be struck by the stick, and with what amount of force).

Any form of percussion music may be utilized to automatically create consumable learning experiences. This is particularly important when addressing the needs of children on the autism spectrum, as they may have a very specific interest in a particular piece of music to the exclusion of others. Also, this method ensures that the cost of creating the learning experiences is reduced, making it available to more children (and adults).

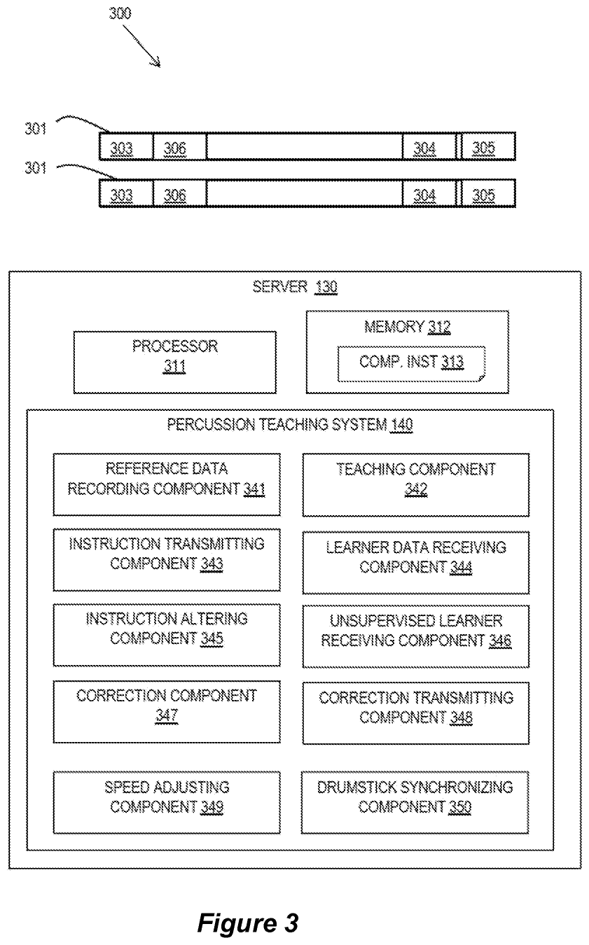

Referring to FIG. 3, a block diagram shows an example embodiment of a system 300 for remote teaching of a percussion instrument.

The system includes a drumstick 301, such as the reference drumstick(s) 101, 102 and the learner drumstick(s) 103, 104, the drumstick 301 having: multiple movement sensors for obtaining movement data of the drumstick 301 over time, where the movement sensors include an accelerometer 304 and an impact sensor 305. The drumstick 301 includes a communication component 303 for receiving and transmitting data to a mobile device such as the tutor mobile device 110 and the learner mobile device 112 shown in FIG. 1, for example via a short-range wireless technology. The drumstick 301 includes a feedback mechanism 306 for providing an indication to a user of the drumstick. The feedback mechanism 306 may include one or more of the group of: a haptic indication mechanism, a visual indication mechanism, and a sound indication mechanism. The feedback mechanism may be a vibration motor for providing vibration to a handle portion of the drumstick in response to received instructions. A pair of drumsticks 301 are shown as it is usual to play with two drumsticks; however, the system may operate with a single drumstick.

The drumstick 301 communicates with a mobile device (shown in FIG. 1) executing a percussion teaching application 120, 122. The server 130 is provided for executing the percussion teaching system 140 in remote communication with the percussion teaching application 120, 122. Functionality described in the server-based percussion teaching system 140 may be provided at the mobile device. The server 130 includes at least one processor 311, a hardware module, or a circuit for executing the functions of the described components which may be software units executing on the at least one processor. Multiple processors running parallel processing threads may be provided enabling parallel processing of some or all of the functions of the components. Memory 312 may be configured to provide computer instructions 313 to the at least one processor 311 to carry out the functionality of the components.

The percussion teaching system 140 may include a reference data recording component 341 for recording reference movement data from the reference drumstick(s) 101, 102 over a period of time.

The percussion teaching system 140 may include a teaching component 342 for analyzing the reference movement data to generate teaching instructions for movement of the learner drumstick 301 to emulate the reference movement data. The percussion teaching system 140 may include an instruction transmitting component 343 for transmitting the teaching instructions to provide teaching instruction indications at the learner drumstick 301 over a period of time.

The percussion teaching system 140 may include a learner data receiving component 344 for receiving learning movement data from the drumstick 301 in response to the teaching instruction indications. The percussion teaching system 140 may include an instruction altering component 345 for altering the timing of the teaching instruction indications based on a difference between learning movement data and reference movement data at a given point of time in the period of time of the reference movement data to compensate for learners learning movement data differences to the reference movement data.

The percussion teaching system 140 may include an unsupervised learner data receiving component 346 for receiving learning movement data from a drumstick 301 without teaching instruction indications. The percussion teaching system 140 may include a correction component 347 for providing correction instructions based on a difference between learning movement data and reference movement data at a given point of time in the period of time of the reference movement data. The correction component 347 may generate correction instructions by analyzing learning movement data received from multiple learners' drumsticks 301 and processing differences between learning movement data and reference movement data at a given point of time in the period of time of the reference movement data and selecting the generated correction instructions in real time in response to received learning movement data.

The percussion teaching system 140 may include a correction instruction transmitting component 348 for transmitting the correction instructions to provide correction instruction indications at the drumstick 301 in real time.

The percussion teaching system 140 may include a drumstick synchronizing component 350 for synchronizing the reference movement data and the teaching instructions between two drumsticks 301 being played at the same time.

The percussion teaching system 140 may include a speed adjusting component 349 for adjusting a speed of the reference movement data.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

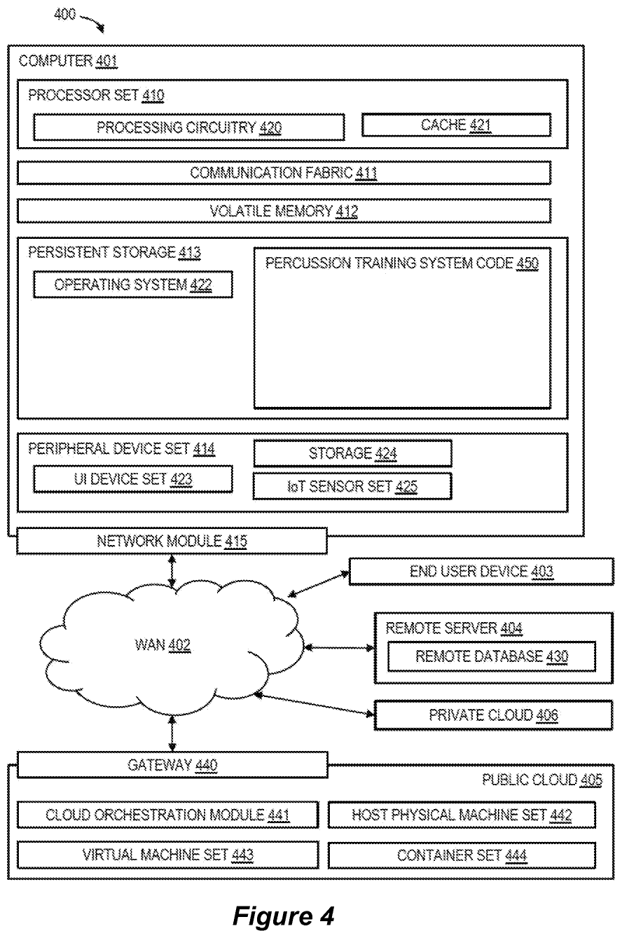

Referring to FIG. 4, computing environment 400 contains an example of an environment for the execution of at least some of the computer code involved in performing the inventive methods, such as percussion training system code 450, or block 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

CLOUD COMPUTING SERVICES AND/OR MICROSERVICES (not separately shown in FIG. 4): private and public clouds 406 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

1. A computer-implemented method for remote teaching of a percussion instrument, the computer-implemented method comprising:
recording reference movement data from a reference drumstick over a first period of time;
analyzing the reference movement data to generate teaching instructions for movement of a learner drumstick to emulate the reference movement data; and
transmitting the teaching instructions to provide teaching instruction indications at the learner drumstick over a second period of time.

2. The computer-implemented method of claim 1, further comprising:
receiving learning movement data from the learner drumstick in response to the teaching instruction indications; and
altering a timing of the teaching instruction indications based on a difference between the learning movement data and the reference movement data at a given point of time in the first period of time of the reference movement data to compensate for a learner's physical use of the learner drumstick to the reference movement data.

3. The computer-implemented method of claim 1, wherein the teaching instructions comprise one or more of timing instructions, direction instructions, speed instructions, and force instructions.

4. The computer-implemented method of claim 1, wherein the reference movement data and the teaching instructions are synchronized between two reference drumsticks being played at a same time.

5. The computer-implemented method of claim 1, wherein the teaching instruction indications are provided to an indication mechanism in the learner drumstick to comprise haptic indications, visual indications, and sound indications.

6. The computer-implemented method of claim 1, further comprising:
adjusting a speed of the reference movement data.

7. The computer-implemented method of claim 1, further comprising:
training a machine learning system with training inputs of sounds of drum music beats from different types of music and reference movement data that provides physical movement characteristics of a cadence, force, and movement of the reference drumstick when playing each type of music with the reference drumstick; and
providing output teaching instruction indications of learned physical movement characteristics from the machine learning system in response to input of a new piece of music.

8. The computer-implemented method of claim 1, further comprising:
receiving learning movement data from the learner drumstick without the teaching instruction indications having been provided to the learner drumstick;
providing correction instructions based on a difference between the learning movement data and the reference movement data at a given point of time in the first period of time of the reference movement data; and
transmitting the correction instructions to provide correction instruction indications at the learner drumstick in real time.

9. The computer-implemented method of claim 1, further comprising:
generating correction instructions by analyzing learning movement data received from multiple learners' drumsticks and processing differences between the learning movement data and the reference movement data at a given point of time in the period of time of the reference movement data; and
selecting the generated correction instructions in real time in response to the received learning movement data.

10. The computer-implemented method of claim 9, wherein generating the correction instructions is carried out by machine learning, where a machine learning system takes as input the correction instructions provided for a group of learner drumsticks and an outcome of learning movement data from the group of the drumsticks to learn which instructions of the correction instructions provide most improvement.

11. A computer system for remote teaching of a percussion instrument, the computer system comprising:
one or more computer processors, one or more computer-readable storage media, and program instructions stored on the one or more of the computer-readable storage media for execution by at least one of the one or more processors, wherein the computer system is capable of performing a method comprising:
recording reference movement data from a reference drumstick over a first period of time;
analyzing the reference movement data to generate teaching instructions for movement of a learner drumstick to emulate the reference movement data; and
transmitting the teaching instructions to provide teaching instruction indications at the learner drumstick over a second period of time.

12. The computer system of claim 11, further comprising:
receiving learning movement data from the learner drumstick in response to the teaching instruction indications; and
altering a timing of the teaching instruction indications based on a difference between the learning movement data and the reference movement data at a given point of time in the first period of time of the reference movement data to compensate for a learner's physical use of the learner drumstick to the reference movement data.

13. The computer system of claim 11, wherein the teaching instructions comprise one or more of timing instructions, direction instructions, speed instructions, and force instructions.

14. The computer system of any of claim 11, wherein the reference movement data and the teaching instructions are synchronized between two reference drumsticks being played at a same time.

15. The computer system of any of claim 11, wherein the teaching instruction indications are provided to an indication mechanism in the learner drumstick to comprise haptic indications, visual indications, and sound indications.

16. The computer system of claim 11, further comprising:
adjusting a speed of the reference movement data.

17. The computer system of any of claim 11, further comprising:
training a machine learning system with training inputs of sounds of drum music beats from different types of music and reference movement data that provides physical movement characteristics of a cadence, force, and movement of the reference drumstick when playing each type of music with the reference drumstick; and
providing output teaching instruction indications of learned physical movement characteristics from the machine learning system in response to input of a new piece of music.

18. The computer system of claim 11, further comprising:
receiving learning movement data from the learner drumstick without the teaching instruction indications having been provided to the learner drumstick;
providing correction instructions based on a difference between the learning movement data and the reference movement data at a given point of time in the first period of time of the reference movement data; and
transmitting the correction instructions to provide correction instruction indications at the learner drumstick in real time.

19. The computer system of claim 11, further comprising:
generating correction instructions by analyzing learning movement data received from multiple learners' drumsticks and processing differences between the learning movement data and the reference movement data at a given point of time in the period of time of the reference movement data; and
selecting the generated correction instructions in real time in response to the received learning movement data.

20. A computer program product for remote teaching of a percussion instrument, the computer program product comprising:
one or more computer-readable storage media and program instructions stored on the one or more computer-readable storage media, the program instructions executable by a computing system to cause the computing system to perform a method comprising:
recording reference movement data from a reference drumstick over a first period of time;
analyzing the reference movement data to generate teaching instructions for movement of a learner drumstick to emulate the reference movement data; and
transmitting the teaching instructions to provide teaching instruction indications at the learner drumstick over a second period of time.
